(19) United States
(12) Patent Application Publication
(10) Pub. No.: US 2020/0134569 A1
(43) Pub. Date: Apr. 30, 2020

(54) ASSESSMENT-BASED TALENT MATCHING

(71) Applicant: HSCI, LLC, Caldwell, ID (US)

(72) Inventor: Shae Taylor, Caldwell, ID (US)

(73) Assignee: HSCI, LLC, Caldwell, ID (US)

(21) Appl. No.: 16/666,246

(22) Filed: Oct. 28, 2019

Related U.S. Application Data
(60) Provisional application No. 62/751,598, filed on Oct. 27, 2018.

(51) Int. Cl. G06Q 10/10; G06F 16/9535

(52) U.S. Cl. CPC G06Q 10/1053; G06F 16/9535

(57) ABSTRACT

Apparatuses, methods, program products, and systems are described for assessment-based talent matching. An apparatus includes a processor and a memory that stores code executable by the processor. The code is executable by the processor to aggregate, in a central repository, a plurality of different assessment results based on a plurality of assessments for a user. Each of a plurality of assessment results may describe different traits of a user. The code is executable by the processor to determine where one or more of a user's traits overlap based on different assessments for the user. The code is executable by the processor to match a user to one or more personalized opportunities determined for the user based on overlapping traits and one or more characteristics of the opportunities.

### CROSS-REFERENCES TO RELATED APPLICATIONS

This application claims the benefit of U.S. Provisional Patent Application No. 62/751,598 entitled “MATCHING, AND FACILITATING INTEGRATION AND ENGAGEMENT” and filed on Oct. 27, 2018, for Shae Taylor, which is incorporated herein by reference.

### FIELD

The subject matter disclosed herein relates generally to recruiting and networking systems and more particularly to assessment-based talent matching and networking.

### BACKGROUND

Typical recruiting systems only consider basic information for a user such as grades, work experience, etc. While these factors are important, other factors that characterize who a person is may be beneficial to recruiters. However, conventional recruiting systems only consider the user's hard factors such as grades and work experience and do not have a way to consider other factors that define who a person is. Furthermore, conventional systems are not focused on diversity inclusion recruiting that promotes greater equality for all candidates and promotes the power of social capital, which is heavily impacted by diversity inclusion.

### BRIEF SUMMARY

Apparatuses, methods, program products, and systems are described for assessment-based talent matching. An apparatus, in one embodiment, includes a processor and a memory that stores code executable by the processor. The code, in certain embodiments, is executable by the processor to aggregate, in a central repository, a plurality of different assessment results based on a plurality of assessments for a user. Each of a plurality of assessment results may describe different traits of a user. The code, in various embodiments, is executable by the processor to determine where one or more of a user's traits overlap based on different assessments for the user. The code, in some embodiments, is executable by the processor to match a user to one or more personalized opportunities determined for the user based on overlapping traits and one or more characteristics of the opportunities.

A method for assessment-based talent matching, in one embodiment, includes aggregating, in a central repository, a plurality of different assessment results based on a plurality of assessments for a user. Each of a plurality of assessment results may describe different traits of a user. In further embodiments, a method includes determining where one or more of a user's traits overlap based on different assessments for the user. In certain embodiments, a method includes matching a user to one or more personalized opportunities determined for the user based on overlapping traits and one or more characteristics of the opportunities.

A computer program product for assessment-based talent matching includes, in one embodiment, a computer readable storage medium that stores code executable by a processor. In certain embodiments, code is executable by a processor to aggregate, in a central repository, a plurality of different assessment results based on a plurality of assessments for a user. Each of the plurality of assessment results may describe different traits of the user. In some embodiments, code is executable by a processor to determine where one or more of a user's traits overlap based on different assessments for the user. In further embodiments, code is executable by a processor to match a user to one or more personalized opportunities determined for the user based on overlapping traits and one or more characteristics of the opportunities.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention, and are not therefore to be considered to be limiting of its scope, the invention will be described and explained with additional specificity and detail through the use of the accompanying drawings, in which:

FIG. 1 is a schematic block diagram of an embodiment of a system for assessment-based talent matching;

FIG. 2 is a schematic block diagram of an embodiment of an apparatus for assessment-based talent matching;

FIG. 3 is a schematic block diagram of an embodiment of another apparatus for assessment-based talent matching;

FIG. 4 depicts one example embodiment of a career planner for assessment-based talent matching;

FIG. 5 depicts one example embodiment of a dashboard interface for assessment-based talent matching;

FIG. 6 depicts one example embodiment of a digital portfolio for assessment-based talent matching;

FIG. 7 is a schematic flow-chart diagram of one embodiment of a method for assessment-based talent matching; and

FIG. 8 is a schematic flow-chart diagram of one embodiment of another method for assessment-based talent matching.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model. The computer program product may be stored on a shared file system accessible from one or more servers.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

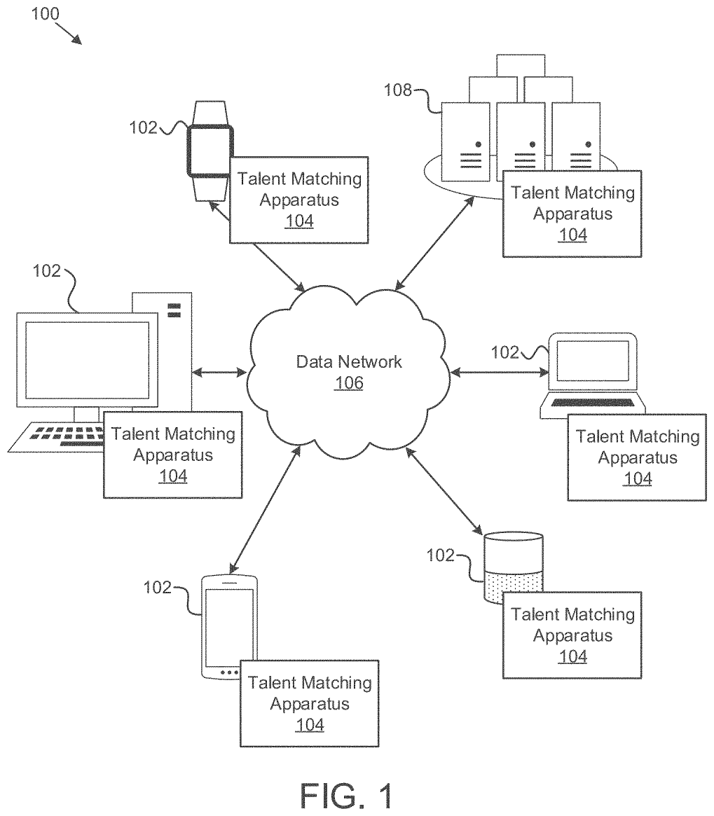

FIG. 1 depicts one embodiment of a system 100 for assessment-based talent matching. In one embodiment, the system 100 may be utilized for a system 100 for self-discovery, matching and facilitating integration and engagement, discovering raw talent (e.g., style and strengths) and/or determining an occupational fit (e.g., fit and interests), or the like. The system 100, in certain embodiments, may create Common Purpose and Language Communities (CPLC) that may be self-sustaining and/or economically thriving by leveraging a turnkey corporate social responsibility strategy. The common purpose may be to begin using a common language of style, strengths, fit, and/or interests throughout a community (e.g., by schools, welfare, corrections, labor, employers, etc.).

In one embodiment, the system 100 includes one or more information handling devices 102, one or more talent matching apparatuses 104, one or more data networks 106, and one or more servers 108. In certain embodiments, even though a specific number of information handling devices 102, talent matching apparatuses 104, data networks 106, and servers 108 are depicted in FIG. 1, one of skill in the art will recognize, in light of this disclosure, that any number of information handling devices 102, talent matching apparatuses 104, data networks 106, and servers 108 may be included in the system 100.

In one embodiment, the system 100 includes one or more information handling devices 102. The information handling devices 102 may include one or more of a desktop computer, a laptop computer, a tablet computer, a smart phone, a smart speaker (e.g., Amazon Echo®, Google Home®, Apple HomePod®), an Internet of Things device, a security system, a set-top box, a gaming console, a smart TV, a smart watch, a fitness band or other wearable activity tracking device, an optical head-mounted display (e.g., a virtual reality headset, smart glasses, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium, a display, a connection to a display, and/or the like.

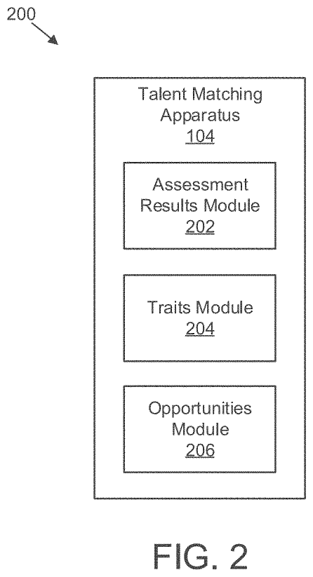

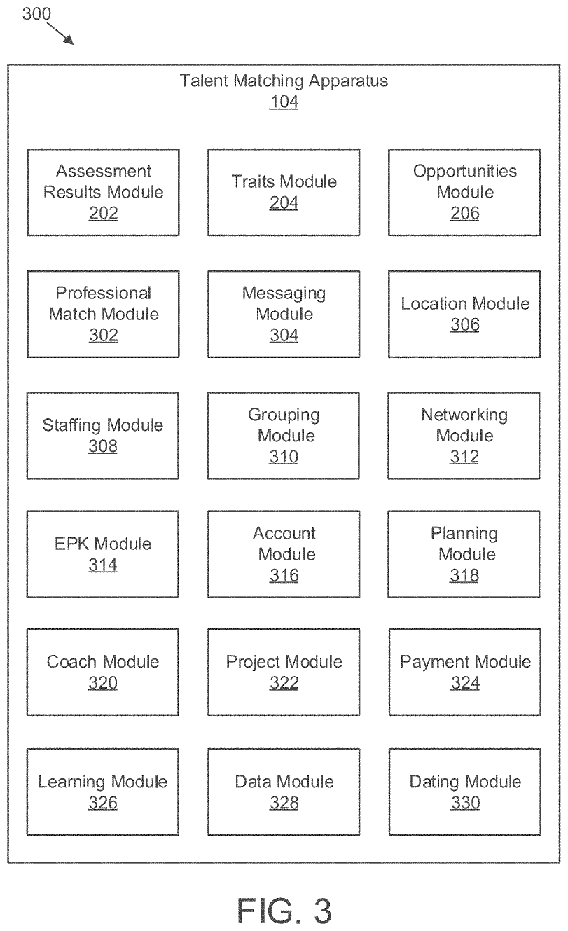

In one embodiment, the talent matching apparatus 104 is configured to receive/archive results from one or more occupation-related assessments, personality assessments, skill assessments, or other assessment programs that may be configured to determine a person's traits such as personality, interests, skills, values, context, abilities, knowledge, activities, styles, talents, aptitudes, or the like. The talent matching apparatus 104, in certain embodiments, is configured to determine where one or more of the user's traits overlap based on the different assessments for the user and match the user to one or more personalized opportunities determined for the user based on the overlapping traits and one or more characteristics of the opportunities. The talent matching apparatus 104 is described in more detail below with reference to FIGS. 2 and 3.

In various embodiments, the talent matching apparatus 104 may be embodied as a hardware appliance that can be installed or deployed on an information handling device 102, on a server 108, on a user's mobile device, on a display, or elsewhere on the data network 106. In certain embodiments, the talent matching apparatus 104 may include a hardware device such as a secure hardware dongle or other hardware appliance device (e.g., a set-top box, a network appliance, or the like) that attaches to a device such as a laptop computer, a server 108, a tablet computer, a smart phone, a security system, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the talent matching apparatus 104 may include a power interface, a wired and/or wireless network interface, a graphical interface that attaches to a display, and/or a semiconductor integrated circuit device as described below, configured to perform the functions described herein with regard to the talent matching apparatus 104.

The talent matching apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the talent matching apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the talent matching apparatus 104.

The semiconductor integrated circuit device or other hardware appliance of the talent matching apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the talent matching apparatus 104 includes and/or is communicatively coupled to one or more non-volatile memory media, which may include but is not limited to: NAND flash memory, NOR flash memory, nano random access memory (nano RAM or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA” ®). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more information handling devices 102. In certain embodiments, the servers 108 are communicatively coupled to the information handling devices 102 via the data network such that the information handling devices 102 may store and/or access data on the servers 108 as it relates to the talent matching module 104.

FIG. 2 depicts one embodiment of an apparatus 200 for assessment-based talent matching. In one embodiment, the apparatus 200 includes an embodiment of a talent matching apparatus 104. The talent matching apparatus 104, in certain embodiments, includes one or more of an assessment results module 202, a traits module 204, and an opportunities module 206, which are described in more detail below.

The assessment results module 202, in one embodiment, is configured to aggregate, in a central repository or a plurality of different repositories that are communicatively connected, a plurality of different assessment results based on a plurality of assessments for a user where each of the plurality of assessment results describes different traits of the user. As used herein, an assessment is a method or tool used to evaluate or estimate the nature, quality, or ability of someone such as tests, quizzes, surveys, or other forms or tools. For instance, the assessment results module 202 may receive/archive results from one or more occupation-related assessments, personality assessments, skill assessments, or other assessment programs that may be configured to determine a person's personality, interests, skills, values, context, abilities, knowledge, activities, styles, talents, aptitudes, or the like.

Examples of assessments or assessment programs/tools/methods may include DISC (behavior assessment tool based on the DISC theory, which centers on four different personality traits which are currently Dominance/Dominant (D), Influence/Influencing (I), Steadiness/Supportive (S), and Conscientiousness/Cautious (C)), Clifton StrengthsFinder Signature Themes, Self-Directed Search Summary Codes, Holland's Vocational Types, The O*NET Content Model, or the like. The O*NET Content Model may include various components, such as worker characteristics (e.g., abilities, occupational interests, work values, work styles, etc.), worker requirements (e.g., skills, knowledge, etc.), occupational requirements (e.g., activities, work context, etc.), or the like.

The assessment results module 202, in one embodiment, monitors and reports completion of inputting data around assessments. In certain embodiments, users may be provided with online assessments that the assessment results module 202 provides and receives the users' responses from. In other embodiments, the assessment results module 202 receives the users' self-reported assessment results. The assessment results module 202 may track which users have completed and entered their assessment results into the system 100. The assessment results module 202 may gather style, strengths, fit, causes, and/or industries of interest, and/or up to five or more jobs by job zone for five or more job zones, or the like.

The assessment results module 202 and/or the traits module 204, described below, may provide substantially real-time instant access to an interpretation of what the results mean and/or cues that indicate how to better engage and/or motivate that given user based on their results. This may help reduce duplication of work while also ensuring a view that may enable group leaders and/or managers to know the work is being completed. Knowing this may help them stay on track and/or identify individuals who need help with certain aspects of the process entering and providing assessment and profile information.

If the data being provided is not done in a timely manner, the talent matching apparatus 104 may be of less value to the group. For example, the first day a student enters a classroom, the teacher may know how to customize learning to that given student if the teacher has the student's result from DISC, which may define the student's style. For example, if a student enters their DISC results into the system, an organizational dashboard may show the result (e.g., D/C) and enable the result to be clicked to show cues on how to work most effectively with that student, or the like.

The users may include one or more people that are a part of an organization and/or receiving benefits from the organization. Groups may be schools (e.g., students or teachers), labor department (e.g., service beneficiaries or employees), corrections department (e.g., service beneficiaries or employees), welfare department (e.g., service beneficiaries or employees), veterans departments (e.g., service beneficiaries or employees), staffing agencies, companies, teams, families, churches, or the like. The talent matching apparatus 104, in one embodiment, stores this information in a central repository for the user to manage and/or share as they move from group to group in a community (e.g., when a student moves between schools. With the high mobility of high school students in rural farming areas or simply because of job relocation of a parent this streamlined information transfer is important to student integration at the new school). The central repository may include a server 108 such as a cloud server or other remote server.

In one embodiment, the results of the user's assessments, as well as other profile information for the user, e.g., contact information, demographic information, and/or the like are presented in a graphical dashboard. The dashboard may include other tools for analyzing the user's assessment results, for contacting potential employers—with opportunities, for networking with other users, and/or the like. The graphical dashboard may be presented in a web browser, in a mobile application, in a social media network, and/or the like.

In one embodiment, the traits module 204 is configured to determine where one or more of the user's traits overlap based on the different assessments for the user. As used herein, overlapping traits may include a person's personality, interests, skills, values, context, abilities, knowledge, activities, styles, talents, aptitudes, or the like that are similar, cooperative, correlative, complementary, and/or the like. For instance, in some embodiments, the traits module 204 compiles the results from one or more assessments to summarize where a user's personality, interests, skills, values, context, abilities, knowledge, activities, styles, talents, or the like, overlap to help the user find the best fit for an occupation, job, service opportunity, scholarship, educational program, internship, job shadow program, apprenticeship, and/or the like.

In one embodiment, the traits module 204 uses machine learning or artificial intelligence to analyze and process the assessment results to determine where the user's traits overlap, where the user's strengths and weaknesses exist, and/or the like. For instance, the traits module 204 may normalize the assessment results based on a predefined system or schema so that the assessment results can be compared against one another, weighted, averaged, and/or the like on a similar basis. Accordingly, the traits module 204 may provide the normalized assessment results, normalized or not, as inputs into a machine learning program, process, algorithm, engine, or the like. The outputs of the machine learning may be values, rankings, scores, or the like that indicate the user's traits that overlap, the user's traits that are unrelated, and the user's traits that are areas of weakness for the user. An example would be to identify which member of the group (or of a user's contacts) has the greatest raw talent for sales.

The opportunities module 206, in one embodiment, is configured to match the user to one or more personalized opportunities determined for the user based on the overlapping traits and one or more characteristics of the opportunities. For instance, the opportunities module 206 may determine a job, an internship, a service project, an internal promotion, a job interview, a job shadow program, a mentorship program, an educational program, an apprenticeship, a scholarship, and/or the like that match with the user's overlapping, or strong, traits. The opportunities may be stored in a central repository and searchable by the user's traits, a description, an employer, and/or the like. The opportunities module 206 may search the central repository for opportunities that are a best match for the user, e.g., opportunities that match the user's overlapping traits according to a threshold match (e.g., 80% match between a description of an opportunity and the user's traits). The opportunities module 206, in further embodiments, determines an opportunity match for the user using machine learning or artificial intelligence by inputting different factors describing an opportunity and the overlapping traits for the user to predict, estimate, or forecast one or more opportunities that are a best match for the user and/or the opportunity provider.

Opportunity providers, such as employers, may upload or provide opportunities and their descriptions, which the opportunities module 206 stores in the central repository for reference. Opportunities may be accompanied by basic data related to the entity with the opportunities, such as in which city, State, and/or zip code the opportunities are available; what the purpose and/or culture of the entity are; if there are any restrictions tied to their offerings (e.g., age or background restrictions); which staffing agencies the entity is partnered with; and/or contact information for each offering so users can streamline communication efforts (e.g., removing the middleman of school guidance counselors, labor department personnel, and/or staffing agency personnel); and/or so opportunity providers can broaden their reach (e.g., beyond local talent pools). With the system 100, an entity (e.g., a celebrity in Los Angeles, for example) that inserts information about a scholarship for users interested in a given O*NET code, will be offering the same opportunity to every user in the system across an entire human capital knowledge management system (e.g., bypassing the need for human transfer of information which otherwise may become a roadblock preventing individuals from knowing what types of opportunities abound around them).

In one embodiment, the opportunities module 206 is configured to aggregate the opportunities offered by one or more organizations in the central repository and sort, organize, or arrange the opportunities by different factors such as by O*NET code, by opportunity provider, e.g., employer, by length of opportunity, by salary, by qualification requirement, and/or the like, which makes the opportunities in the central repository easier to browse, search, or the like by an applicant, candidate, or the like.

In one embodiment, the one or more personalized opportunities are determined according to O*NET codes that correspond to the user's overlapping traits. As used herein, an O*NET is an example of an occupational information network that comprises a database of occupational requirements and worker attributes. An O*NET code may comprise a code that describes occupations included in the O*NET in terms of the skills and knowledge required, how the work is performed, and typical work settings. O*NET equivalents for various countries may be used in the system (e.g., Canada has their own taxonomy that may differ from O*NET codes used in the United States) Moreover, the O*NET data stored on users can be used by businesses, educators, human resources professionals, and/or other organizations to help match a job seeker with an employer or industry professional who has opportunities for this user to help advance their lifelong learning or career based on their assessment results and/or desired O*NET codes of interest. For those under 18 years of age, the matching is provided anonymously to comply with FERPA laws.

In one embodiment, the traits module 204 may determine a user's fit for an opportunity in terms of an O*NET code (e.g., orthodontist—29-1023.00) for up to a certain number of opportunities, e.g., up to 25 jobs (e.g., including up to five per job zone, yielding a potential five for job zone 1, five for job zone 2, five for job zone 3, five for job zone 4, and five job zone 5). The traits module 204, for instance, may use machine learning or other analytical process to estimate or predict O*NET codes for opportunities that match the user's overlapping traits based on descriptions of opportunities that correspond to certain O*NET codes and the user's traits. The opportunities module 206 may tie a user's jobs of interest to a set of O*NET codes and then archive them in a knowledge management system on the central repository, or the like, to be leveraged by the user and/or prospective employers.

In one embodiment, the traits module 204 may use machine learning to predict or estimate O*NET codes to match the user's traits as determined from the assessment results. For instance, the traits module 204 may input the user's assessment results into the machine learning to determine the user's overlapping traits and also O*NET codes that correspond to the user's overlapping traits, e.g., O*NET codes the correspond to opportunities such as jobs that match the user's overlapping traits. The opportunities module 206 may use the predicted O*NET codes to determine one or more opportunities that are a best fit for the user, e.g., by referencing the opportunities database in the central repository by the generate O*NET codes.

Automation of the matching process by the opportunities module 206 for opportunities based on O*NET code may be completed through a partner portal, or the like, which facilitates the matching process and the storage of different types of opportunities offered by employers and/or industry professionals that are related to or classified by O*NET codes. In one embodiment, the opportunities module 206 allows a user to search the central repository for opportunities by job zone and/or job titles. The opportunities module 206 may generate a report for prospective employees that includes a list of organizations that offer those opportunities based on O*NET code, which may be organized by location, job zone, or the like. The opportunities module 206 may provide a centralized retrievable database of employers that offer opportunities (e.g., jobs) based on O*NET code, or the like.

In this manner, the talent matching apparatus 104 can dynamically and automatically match a user to various opportunities using the user's assessment results using assessments that are configured to measure the user's traits beyond merely test scores and grades, but also emphasizes the user's interests, personality, mental health, creativities, and/or other factors, parameters, or traits that are not analyzed or considered in other systems. The talent matching apparatus 104 may provide a turnkey corporate social responsibility initiative strategy that accompanies a process which engages employers and/or industry professionals and may enable them to capture the benefits of being socially responsible by giving back to users in form of informational interviews, job shadowing, apprenticeships, or the like. For instance, the talent matching apparatus 104 provides a diversity inclusion recruiting platform that promotes greater equality for all candidates and promotes the power of social capital, which is heavily impacted by diversity inclusion.

For instance, organizational leaders may not be able to effectively make decisions without up-to-date (e.g., real time) information outlining detailed requirements of work projects, budgets, cash flow, or the like (e.g., business intelligence solutions). It may be the same with human and social capital. Organizational leaders may not be able to effectively recruit/align employees to attack projects without an enhanced understanding of the human and/or social capital at their disposal made available through their employees and their personal networks (which grows in power as each employee uses this system as a social network wherein they migrate all of their other social and professional network connections into to boost their social capital in front of employers, managers, recruiters). In some instances, business intelligence solutions may only be as powerful as the human capital talent put in place to manage them, matched with the social capital those individuals are able to generate within their respective spheres of influence. The talent matching apparatus 104 may provide the missing component to not only effectively manage human/social capital for organizational leaders but to attract it to their organization from a young age (e.g., prior to the individual being hired by the company), and then to onboard it more effectively, accelerating time to engagement and/or productivity.

In another example embodiment, the talent matching apparatus 104 may facilitate the placement of students with teachers and classes prior to the beginning of each new semester/trimester/quarter/year, which would remove teacher biases, improve efficiencies in the classroom, improve student performance, and improve teacher evaluations. For instance, before the first day of school a teacher could know who is in their class, what the students' learning styles/personalities are, their strengths, fit, interests, tendencies, weaknesses, and/or the like. This may enable the teachers to gain trust with the students as well as give the teacher insights into how to best customize learning opportunities for each student.

FIG. 3 depicts one embodiment of an apparatus 300 for assessment-based talent matching. In one embodiment, the apparatus 300 includes an embodiment of a talent matching apparatus 104. The talent matching apparatus 104, in certain embodiments, includes one or more of an assessment results module 202, a traits module 204, and an opportunities module 206, which may be substantially similar to the assessment results module 202, the traits module 204, and the opportunities module 206 described above with reference to FIG. 2. In further embodiments, the talent matching apparatus 104 includes one or more of a professional match module 302, a messaging module 304, a location module 306, a staffing module 308, a grouping module 310, a networking module 312, an EPK module 314, an account module 316, a planning module 318, a coach module 320, a project module 322, a payment module 324, a learning module 326, a data module 328, and a dating module 330, which are described in more detail below.

The professional match module 302, in one embodiment, is configured to match the user to a professional associated with an organization offering the one or more personalized opportunities based on the user's traits being similar to the professional's traits and/or the qualifications for an opportunity. Similarly, the professional match module 302 is configured to match a professional with one or more different users who are seeking opportunities or who may otherwise be a good fit for an opportunity that the professional is offering for his/her organization.

The talent matching apparatus 104 stores various types of data received from the user, other external sources, and/or generated based on the data received from the user and/or external sources in a central repository. The central repository may be located on the server 108, which may be located on a local network, remotely on the cloud, or the like. In this manner, job/opportunity seekers and prospective employees may be able to control their employment search efforts and/or empower employers or industry professionals to discover them for their interest by O*NET code and/or raw talent. Similarly, employers can use the data categories in the database to better manage their talent search efforts in order to find employees who may fit various characteristics of the company and roles available, such as culture, morals, values, skills, etc.

Additionally, data may be used to find candidates, applicants, or other talent that possess qualities similar to the same company's top performers in a given role. The professional match module 104 may allow the employer to aggregate assessment results from top performers within their organization so they know what types of users to attract/recruit for their offered opportunities. The professional match module 104 may comprise an automated matching system based on assessment results from DISC, StrengthsFinder, and/or Self-Directed Search such that when a user's data matches that of a top performer the professional match module 104 may display the match to the user, to an administrator, manager, employer, or other user at the company, or the like. The professional match module 104 may provide a matching process built around style, strengths, fit, and/or interest. In certain embodiments, the professional match module 302 is configured to tag certain users such as children of billionaires, millionaires, c-level executives, foster kids, children's miracle network kids, and/or the like to help organizations further prioritize their goals/approach in recruiting talent which might be impacted at least in part based on the tags attached to a candidate's profile.

In certain embodiments, the professional match module 302 enables organizations and/or partners (e.g., companies, schools, sports teams, and/or the like) to create public websites, social media sites, and/or the like to showcase their company and offerings. The profiles may present the organization's purpose, culture, staffing partners, contact information, and/or the like and may showcase organizational heroes/and some of their style and strength characteristics that helped them excel. The organizations can also showcase the performers they have in different roles within the organization and a summary analysis of their top performers so people looking to jump onboard organizations for given roles will know if they are a good match or not. For example, an interviewee may view the company's profile page to determine who will be present in the interviews and also determine the interviewers' tendencies, traits, styles, and/or the like so that the interview goes smoothly from both sides and the interviewee is not blind-sided prior to the interview.

In one embodiment, the professional match module 302 highlights or presents “heroes” within an organization or other field. The “heroes” may include superstar athletes, C-level executives, educators, community volunteers, politicians, astronauts, and/or the like. The professional match module 302 may use a “hero's” assessment results to compare with the user's results to give the user an idea of which “hero” they are most like. This may be used as an incentive to get users to take the assessments and to take them seriously.

In one embodiment, the professional match module 302 presents one or more O*NET codes, or the like, to an employer that the employer can select in order to find prospective candidates/applicants who have specified the same O*NET codes. In response to the employer's selections, the professional match module 302 may generate one or more reports (e.g., pie charts of candidates showcasing the results from the assessments for all the users interested in that same code). For example, the professional match module 302 may generate a report for an organization that lists one or more prospective candidates that fit the criteria for the organization, based on the O*NET codes selected by the employer and the assessment results (e.g., DISC: D/C) provided by the prospective employees. The professional match module 302 may provide pie chart summaries of candidates that highlight the types of candidates available based on the population's style, strengths, fit, and/or interest. These charts may provide employers with a second tier view of the candidate pool, or the like.

In one embodiment, the professional match module 302 hides certain information tied to a given candidate if the candidate is under 18 years old (or younger than a statutory adult age for the candidate's location) to satisfy statutory and regulatory requirements such as the Family Educational Rights and Privacy Act (FERPA), or the like. As an example, the name of a candidate may be represented as J.D. instead of their real name, John Doe. Additionally, other personally identifiable information may be obscured from view until the user indicates they are over 18 in the user's profile.

In one embodiment, the professional match module 302 allows organizations providing opportunities to generate promotions that users can enter and/or win to receive prizes that facilitate the user's growth. For example, a promotional prize may to have an informational interview with Shaquille O'Neal. The user may enter to receive the promotion by completing certain steps towards finishing the user's profile (e.g., completing an assessment, entering assessment results, contacting other users for networking, and/or the like). The organization providing the promotion may receive profile information, e.g., assessment results, from each user who entered the promotion. As opposed to a lottery where every entrant has an equal opportunity to win, the promotions described herein allow the organization that is providing the promotion to consider the profile information of the entrants and select one or more entrants as winners based on whether the entrants are a good fit for the organization, have strengths/styles/personalities/fit/etc. that matches the organization, and/or the like. In this manner, the organizations can be selective about who they choose to receive the promotion in an attempt to recruit the best fit possible for the organization or the opportunity.

In one embodiment, the messaging module 304 is configured to allow a candidate to contact an opportunity provider, and vice versa (e.g., an employer to contact prospective employees) by pinging them (e.g., by sending a notification directly to the candidate) via email, instant message, phone, text, social media message, push notification, or the like. For example, when an employer or industry professional identifies a candidate with a satisfactory match (e.g., one where a candidate matches that of their top performers), they can notify the user of the type of opportunity they would like to communicate with them about “via ping” and provide them instructions for how to contact them. For user candidates under 18 this functionality is limited to conform to laws such as FERPA (e.g., minors may only be allowed to contact persons who their parents have approved or who have otherwise been designated as authorized contacts).

In certain embodiments, once a ping is clicked by the candidate's name in a graphical interface, a pop-up appears that highlights the types of offerings previously selected by the employer, or the like. The employer, in certain embodiments, simply has to select an opportunity type (e.g., informational interview, job shadowing, internship) and then click send. The previously stored data related to the offering and the accompanying contact details may be automatically retrieved and sent to the user's graphical dashboard, in an email, in a text message, in an instant message, in a push notification, in a social media message, or the like. Another example might be to partner with a telecom provider to create a package where users agree to give incoming callers the option to access cues, e.g., cues about the user's traits—interests, personality types, etc., to optimize/prepare for the conversation they are about to have (which is possible because the behavioral style of the user is in the central repository based on the user's assessment results).

As prospective employees receive pings and/or notices/letters of interest from organizations interested in their unique abilities, it may create within the user a powerful feeling that comes with being recruited, further motivating them along their career pursuits. This may also empower users to refine their networking efforts, and/or to better allocate their time as they investigate and apply for opportunities. Additionally, prospective employees may be encouraged to reach out to staffing agencies focused on their specific area of focus (e.g., such as by O*NET code) so that the staffing agencies can help promote the prospective employee's abilities to the employer as well as prepare them for job interviews, performance reviews, resume creation, or the like.

The location module 306, in one embodiment, is configured to track the user's location based on location data received from one or more location sensors for the user, e.g., smart phone GPS sensors. In such an embodiment, one or more personalized opportunities may be selected for the user based at least in part on the user's location. For example, a user sitting at a bus stop in San Francisco may receive notifications, emails, push notifications, or the like for opportunities in the user's area that match the user's traits, other users within the user's proximity who have similar traits to the user's (or that would be complementary), professionals within a proximity of the user's area who have expressed interest in meeting with potential candidates for opportunities that meet the user's traits, and/or the like.

By tracking the user's location, the location module 306 can determine migration patterns of talent. As talent moves around geographic locations, the opportunities module 206 can present unique, target, and customized opportunities to the users (e.g., experiences, advertising, sales, or service) based on the user's location and the opportunities that are offered within the user's location. Government agencies, municipalities, and/or other local governments may use the user information, e.g., demographic information, to measure trends in the available raw talent to help make decisions for economic development, education, and/or the like.

The staffing module 308, in one embodiment, is configured to determine staffing agencies that are used by organizations offering the one or more personalized opportunities and promote the user to the staffing agencies using the user's traits as determined from the one or more assessments. For instance, the staffing module 308 may provide the aggregation of a centralized database that stores information about staffing agencies that employers use based on O*NET code, job zone/location, or the like. The staffing module 308 may promote talent, e.g., users, applicants, candidates, etc., to top staffing agencies, based on the user's assessment results, so that the staffing agencies can work with the talent to prepare them for interviews or jobs at the organizations that they represent.

Similarly, the staffing module 308 may provide prospective employees with online links to and/or encouraged to reach out to coaches of the various assessments (e.g., DISC, StrengthsFinder) so they can learn how to better understand themselves and those they might work with into the future. The staffing module 308 may match coaches of the various assessments to individuals' assessment results of users thereby empowering users to find the right coaches for them and their style, strengths, fit, and interests faster.

In one embodiment, the grouping module 310 is configured to include a user in one or more groups with other users and determine one or more traits of the one or more groups based on the individual traits of each user in the one or more groups according to the assessment results for each user. For instance, the traits module 204 may analyze the assessment results for each user in the group, e.g., using machine learning, to determine an overall makeup of the group, e.g., the controlling personality trait of the group, the interests of the group, the communication style of the group, and/or the like.

The grouping module 310, in one embodiment, organizes or arranges current users (e.g., students) into sub-groups so that group leaders (e.g., teachers) can compile a more comprehensive understanding of an organization's existing culture, interests, talent base, or the like. This sub-grouping process may provide summaries built around the group's style (DISC), strengths (StrengthsFinder), fit (SDS), and interests (O*NET), which may be used in these subgroups to showcase the dynamics of the whole group's style, strengths, fit, and/or interests. To view this data, the grouping module 310 may generate a group chart (e.g., how to tie in this third party assessment result via use of an access code), may compare user styles (e.g., how to simplify the selection of who to compare and which category will be compared), may determine potential style synergies (e.g., how a user's assessment results automatically generate the names of people with complementary styles from within the group and then provides support details from the other assessments), and/or the like.

The grouping module 310 may provide the actual segmentation of a group database on these dynamics in real-time so that group leaders and/or members may substantially and instantly see the potential synergies within seconds of the group being formed, or how new additions being added to the group or existing group members removed from the group impacts the group's synergy including potential style tensions and/or disconnects (e.g., how a user's assessment results automatically populate them and/or their style in relation to other group members).

The grouping module 310, in certain embodiments, may provide the ability for group leaders and/or members to instantly see in numerical and/or percentage value the makeup of the group's style, strengths, fit, and/or interests. This may enable group leaders to modify how they manage and/or develop this group. The grouping module 310 may provide the ability to click into a pie chart result, for example, from any one of the categories within styles, strengths, fit, and/or interests to see which users in the group made a given selection and then have all of the user's other assessment results (and their meaning) and/or interests tied to that result, discover hidden talent (e.g., how a user's assessment results automatically populate a breakdown of the actual capabilities of the members of the group).

The grouping module 310 may provide the ability to tie what the traits/talents mean (e.g., that a user has great potential in sales, negotiation, management, or the like), so leaders of the group can better respect, support, and/or promote the trait/talent within the group and/or help users analyze their career planner and the O*NET codes they are considering to pursue. Further, the grouping module 310 may facilitate an innovator safe zone—how a user's assessment results automatically populate a breakdown of which users in the group may be most receptive to helping nurture new idea formation. The grouping module 310 may provide the actual segmentation of a group database based on these dynamics so group leaders and/or members can substantially, in real-time, instantly see which users are most prone to support and help nurture their ideas to give the ideas the best chance for survival.

Another tool that the grouping module 310, in some embodiments, may provide is communities within the group and/or without based on style, strengths, fit, and/or interest. In a community, the grouping module 310 may allow a user to ask for insights from specific types of people how something may be perceived by people like them based on the user's style, strengths, fit, geography/location, or the like. This may be used for new product development surveys, for example. This information and the use of these tools overall may facilitate networking, training, mentoring, and/or group assignments based on different criteria that the grouping module 310 compiles about a group (e.g., the traits or makeup of the group).

For example, this feature with its supportive tools may be used by employers desiring to track and manage the diversity of their members to help enhance the ability to align groups for inclusion/acceptance, to motivate and reward teams toward enhanced performance, and/or improve the overall experience for everyone. The functionality of the grouping module 310 may empower organizations with the ability to help their personnel find purpose in their differences and/or to finally put those differences to work for the benefit of their organization and/or the surrounding community. The grouping module 310 may be especially beneficial to those employing minorities (e.g., gender, race, age, body-type, religion, education level, socio-economic classes, or the like) seeking greater acceptance and/or belonging.

In one embodiment, the grouping module 310 transfers the data of a user to a new group in response to the user being assigned to the new group. This seamless mobilization of data (and/or the meaning of the data), post approval by the users, may save organizations from having to rediscover similar information and/or waste time and money to rediscover the data. For example, when one user that is a high school student moves into a new school district and/or school, the information he/she has already entered or provided to the central repository may travel with them by simply entering their name and email and in real time be made available in one or more of the tools for that new group for the new school district/school.

The networking module 312, in one embodiment, is configured to identify one or more other users who have traits that are similar to the user's traits and present to the user at least a subset of the one or more other users that are located within a predetermined proximity of the user. For instance, the networking module 312 may provide a listing, map, or the like of other users who have similar traits to the user's based on the user's and the other users' assessment results. For example, the networking module 312 may generate a “networking radar” to visually show the user where other similar users are located on the map relative to the user's location, including the other user's contact information, if available, so that the user can reach out to the other users for networking opportunities. In further embodiments, the networking module 312 allows a user to see potential contacts in a different user's network that have similar traits, interests, styles as the user and who could potentially be a potentially new networking relationship for the user.

The networking module 312, in certain embodiments, shares behavioral traits, strengths, and interests with the user's contacts to help each other better understand and work together more effectively as well as to support one another in career aspirations. The networking module 312 may analyze and provide instant insights for a user's contact base to help the user identify raw capacities of his/her contacts (e.g., finding those with rare sales or teaching abilities) and one level deeper into the contacts of their contacts. The networking module 312 may determine which of the user's contacts are most complementary to the user's behavioral strengths and/or possess the traits necessary to protect or strengthen the user's behavioral weaknesses. The networking module 312 may provide an aggregate summary of the industries and causes of interest of the user's contact base and may enable users to instantly identify which contacts might be the best to approach for investment capital for new ideas. The networking module 312 may segregate the user's contacts based on behavioral gifts, behavioral tendencies, motivators, or ideal/leader manager traits so that user can decide which contacts the user may work well with or which contacts the user may struggle to get along with.

In one embodiment, the EPK module 314 is configured to generate an electronic press kit (“EPK”) for the user that describes the user's traits as determined based on the assessment results. In certain embodiments, the EPK module 314 makes the user's EPK publicly accessible over a data network, e.g., as a website, social media page, Instagram® feed, or the like. As used herein an EPK is a set of promotional materials of a person, a company, or an organization that is distributed to others in an electronic form (e.g., a user profile URL that contains insights into their style, strengths, and/or fit and how to manage and/or develop it). The EPK may comprise a digital portfolio for showcasing items related to the user's traits (e.g., the user's style, strengths, fit, and interests), reviews of the user, the user's resume, the user's assessment results, the user's interests, the user's education/internships/volunteerism, favorites, hobbies, multimedia items, and/or the like. The EPK module 314 may provide a public profile that contains assessment results and/or the meaning of those results. Doing so may enhance other people's ability to understand and/or work with these users toward the accomplishment of common goals.

The EPK, for example, may include data such as DISC results (Style), SDS codes (Fit), StrengthsFinder themes (strengths), industries or causes of interests, companies they have worked for or interned with, in the past, positions they have held, portfolio work examples, social/professional network statistics, or the like. The EPK module 314 may direct colleagues to a person's more complete online profile. For example, when a person meets a new acquaintance at a networking event, the user may hand them a business card with their profile URL on it where the new acquaintance can go learn how to work most effectively with this individual into the future. This may accelerate trust and/or relationship building between new acquaintances thereby revolutionizing networking efforts and/or the value of networking events.

The EPK module 314, in some embodiments, showcases colleagues' profiles (or heroes profiles) that have similar traits/capacities as the person whose EPK/URL they are visiting. This may accelerate the individual's ability to understand and/or relate to this new acquaintance. The EPK module 314 may provide the capacity to quickly see others in a user's network with similar traits to the new person they have met or to the team member they were recently assigned to work with.

The account module 316, in one embodiment, creates and/or manages one or more user accounts for prospective employees, employers, organizations, families, sports teams, or the like. In one embodiment, the account module 316 links or connects a plurality of user accounts such that data compiled from the users associated with the user accounts can be tracked. In this manner, a user can gain a better understanding of the human capital another user has to offer as well as the collective social capital of the organization's network.

In one embodiment, the planning module 318 is configured to generate a career planner/matrix for the user based on the user's assessment results, which may be used by career counselors, teachers, coaches, and/or parents to better help align educational and/or experience based opportunities for an individual based on what is relevant to their answers. The career planner/matrix may comprise a report that describes each of the user's results from the various assessments, explains the user's strengths and weaknesses based on the assessment results, and describes other traits and interests for the user. The career planner, in certain embodiments, organizes the user's interest around O*NET codes, industries, and/or causes. The planning module 318 may also tie in one or more definitions of the meaning behind the assessment results around style, strengths, and/or fit from DISC, StrengthsFinder, and/or Self-Directed Search. The career planner/matrix may also show the user's education level and experience.

In certain embodiments, the planning module 318 may provide the user's weaknesses, based on the user's assessment results and/or the qualifications/requirements for an opportunity, and generate different actions and/or plans for the user to strengthen or correct the user's weaknesses. Furthermore, the planning module 318 may present different challenges or scenarios where the user may struggle given the user's perceived weaknesses. Furthermore, the planning module 318, as part of the career planner, may determine an estimated or anticipated wage (e.g., per month, day, hour) for different opportunities/jobs, and a breakdown of various costs such as housing, food, gas, utilities, and/or the like to provide users (e.g., high school students) with an idea of what to expect.

In one embodiment, the coach module 320 connects users with third-party coaches who possess similar types, traits, talents, interests, styles, or the like as theirs (and/or are complementary to theirs) and who can help the user complete their profile, understand the meaning of their assessment results, analyze their career planner, learn how to navigate the system, and/or the like. In one embodiment, the coach module 320 may link to existing coaching services for various assessment programs, such as Gallup StrengthsFinder, Self-Direct Search, DISC, or the like. The coach module 320 may facilitate the alignment of coaches based on the user's composite whole of assessment results and interests, not simply one of the assessment results.

The project module 322, in one embodiment, searches groups of users to identify users with similar qualities, traits, interests, experiences, or the like to align people with similar or different characteristics to work together according to the requirements of a project or task, which may comprise all users or users that are just in one or more groups that the user is a member of. For example, some projects may require a team with similar characteristics while a different project may be completed best using a team of users with dissimilar characteristics. The project module 322, based on the qualities, interests, and geographic locations of users, may identify and recommend the best team members to help solve problems or even role models and mentors for different users. The project module 322 may provide use of users' assessment results and other profile data to identify users that should be recruited to help solve (global, regional, and/or corporate) problems, to be role models or mentors.

In various embodiments, the payment module 324 allows organizations to upgrade to have a payment gateway and/or referral code tied to their organization to create paid access to an exclusive network. When a payment gateway is inserted and a partner code is used, a revenue sharing for access to the group opportunity may be created thereby empowering organizations to monetize access to an exclusive network. The payment module 324 may provide the processing functionality to access an exclusive paid access group wherein users are looking to gain access to the groups style, strengths, fit, and/or interests. For example, a high-powered group of entrepreneurs that network on a regular basis may offer paid membership access to their group members. Networking groups may also do the same, or the like.

In one embodiment, the payment module 324 provides an option for the user to purchase assessments, or access codes for the assessments, e.g., such as purchasing each of the DISC, StrengthsFinder, and Self-Directed Search assessments individually or combined and complete the assessments within the system 100. In this manner, the purchase process can be streamlined to make it easier for users to buy and use access codes for the assessments to complete their user profiles.

The learning module 326, in one embodiment, may offer a learning center for the user so they can better understand the meaning of their assessment results as it relates to style, strengths, and/or fit. The learning module 326 may provide a learning style around a person's style, strengths, fit, and/or interests. For example, a user can learn how to develop their ‘Futuristic’ strength from their StrengthsFinder assessment by gaining instant access to quick reference materials related to the ‘Futuristic’ strength.

The data module 328, in one embodiment, is configured to export the user's data in the central repository to one or more organizations in response to the user providing consent to export their user data such that changes made to the data in the central repository are pushed to one or more organizations that have opted-in to receive data updates. For instance, the data module 328 may export the user's data to an enterprise resource planning and/or business intelligence system for an organization to present users to the organization who match with internal opportunities at organization based on the assessment results for the users to monitor for current and future talent. For example, a company may identify talent when they are 14 years old and provide or guarantee them scholarships when they are 16 if the talent stays on a predefined pathway or completes certain requirements related to working at the company when they are finished with college.

In further embodiments, the data module 328 provides application programming interfaces (“APIs”) to allow connections to the central repository for data extraction, e.g., the user's assessment results and profiles. In certain embodiments, only user data for users who have opted-in to provide their data to certain organizations may be made available via the APIs.

For example, a group like NXTBoard may be looking to help school districts better govern themselves to generate higher student performance. They might query the central repository for data about their user superintendents, school board members, or students to import into their existing platform so when their platform tracks which users are ‘College Ready’ or ‘Proficient in Math’ they can go a level deeper to understanding the type of kids that are succeeding or falling short. Once they are able to identify struggling students, and their traits or characteristics, they can adapt approaches/training/teachers to help districts better govern to success. At this point, once data is gathered and organizations are ready to act, the coach module 320 may be used to determine coaches who can come in and help the organization move things forward.

The dating module 330, in one embodiment, is configured to provide a dating service and community to the user based on the different assessments such as DISC and StrengthsFinder. The dating module 330 may select or identify different potential dates in the central repository that match the user in terms of qualities that the user is looking for in a partner and/or the potential dates' assessment results and other profile data for the potential dates. In this manner, the user may use the assessment results and other data from a potential date's profile to determine and understand the tendencies, traits, styles, and/or the like of the potential date. This will help them navigate the dating and courting process more easily while empowering both individuals to better support one another in their personal improvement and career aspirations.

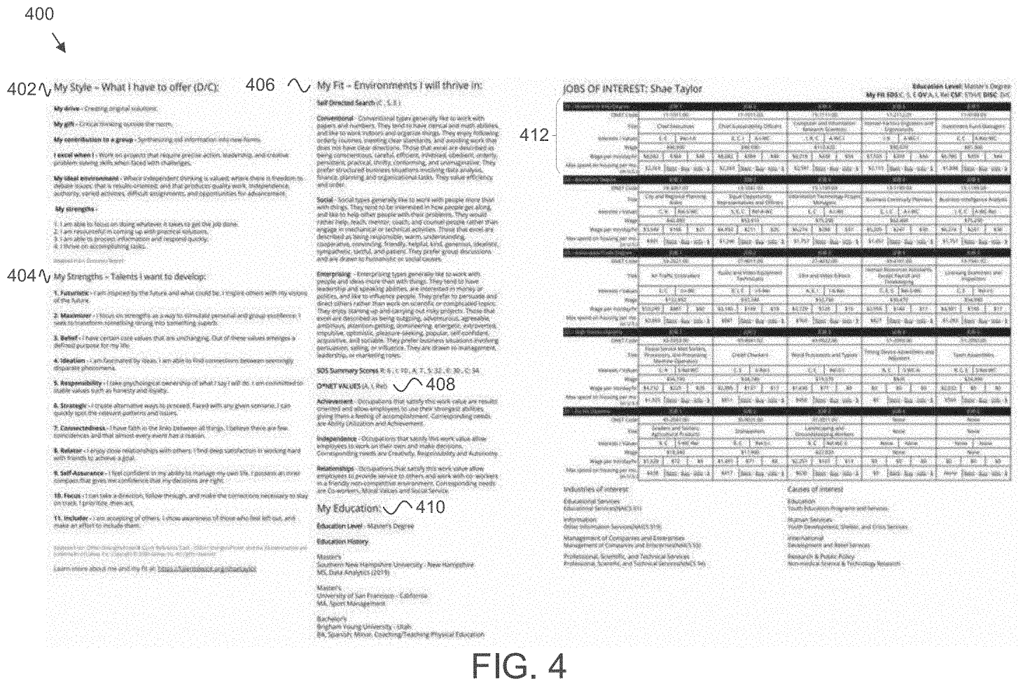

FIG. 4 depicts one embodiment of a career planner 400 that the planning module 318 generates according to the user's assessment results, demographic information, and/or the like. For instance, the career planner 400 may include a section on the user's style 402 as measured from the DISC assessment, the user's strengths 404 as measured from the StrengthsFinder assessment, and the user's fit 406 as measured from the Self-Directed Search assessment. Furthermore, the planning module 318 may include one or O*NET codes 408 that match the user's traits and also includes the user's education 410.

In the depicted embodiment, the career planner 400 may include one or more jobs 412 of interest that are listed by education level (e.g., Ph.D., Master's degree, Bachelor's degree, Associates/Trade degree, high school diploma, no degree, or the like) and include various occupations at each education level that match the O*NET codes for the user. Furthermore, the jobs listings 412 may include various descriptions for each job including the wages for each job broken down per-month, per-day, per-hour, or the like. It also provides third-party insights into the rental and buyers market (and safety/school information) in regions where they might want to live based on their potential earning capacity. Giving users a visual representation of what someone could afford based on their career decision could motivate them toward higher paying jobs and more education to secure them. It also provides access to a third-party insight on how to qualify for buying a home and what it would take to secure a first mortgage. These are the ‘Rent’, ‘Buy’, ‘Info’, and ‘$’ sections.

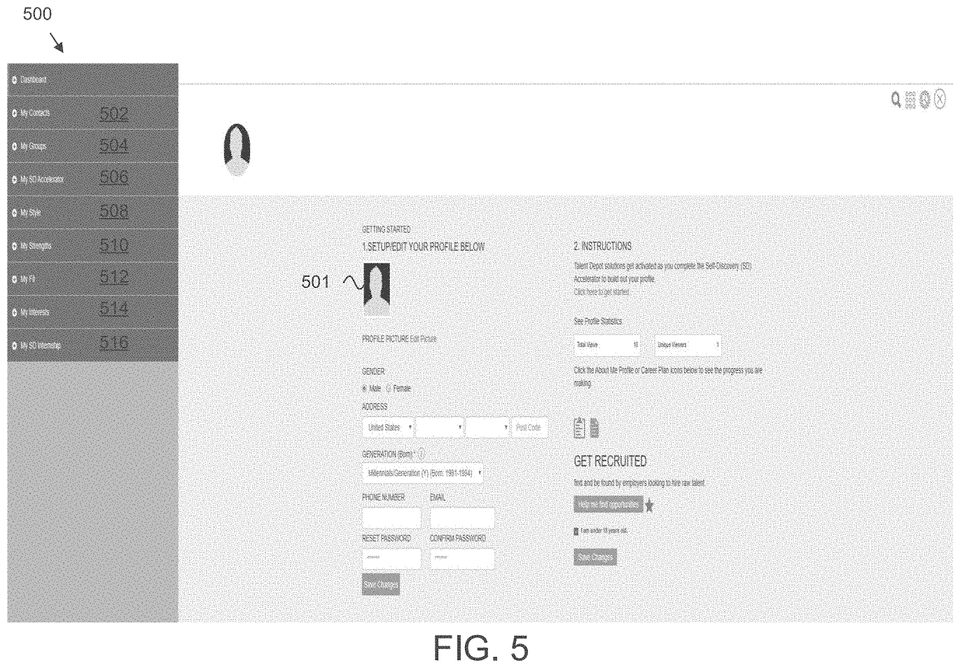

FIG. 5 depicts one embodiment of a user's dashboard 500. The dashboard 500 may include profile information for the user 501, including the user's basic demographic information. Other information is accessible from the user's dashboard including the user's contacts 502, groups 504, assessments 506, assessment results including the user's style 508 from the DISC assessment, the user's strengths 510 from the StrengthsFinder assessment 510, the user's fit 512 from the Self-Directed Search assessment, the user's interests 514 (which provides them a region to study more about their jobs, industries, and causes of interests through third-party providers), and a self-discovery internship, which may be proprietary information that is made available via a third-party 516.

As shown in FIG. 5, each of these sections can be expanded to show additional information based on the user's assessments and other information so that the user can drill down into the different areas to get more detailed information about, for example, the user's style 508 and how that can be used to the user's advantage, opportunities that match with the user's style, contacts that share the user's style, and so on. Furthermore, this information may be provided to an opportunity provider in real-time as the user updates certain information. The dashboard 500 may be accessible via a web browser, a mobile application, and/or the like.

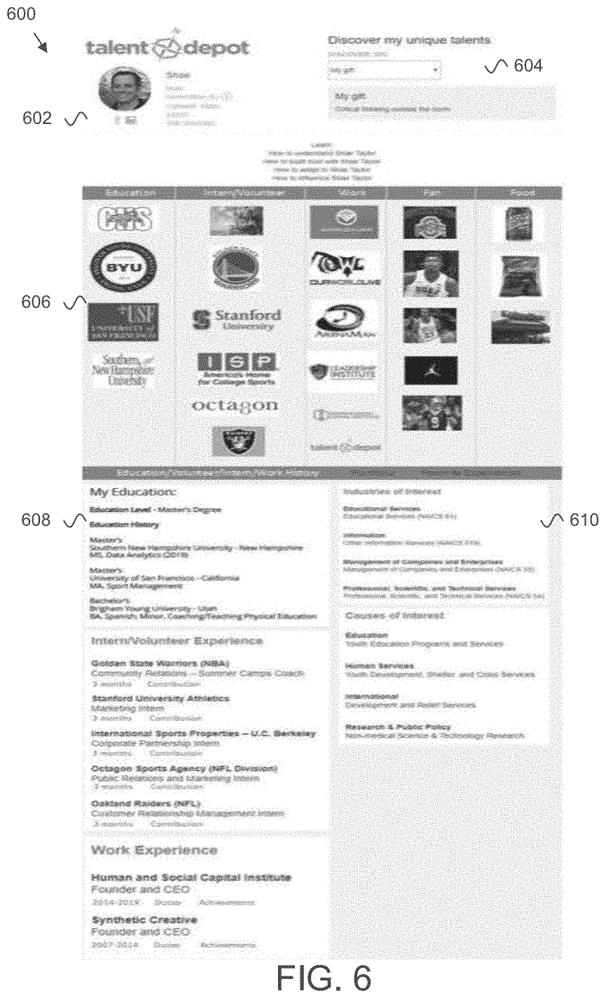

FIG. 6 depicts one embodiment of a user's digital portfolio 600. The digital portfolio 600 may be accessible via a URL or other web address, a social media post, a push notification, an email, a text message, and/or the like. In one embodiment, the digital portfolio highlights or showcases the user and provides basic user information 602 and a section on the user's unique talents 604, as determined according to the user's assessment results. Furthermore, the digital portfolio may include a section on the user's interests 606 and a resume section 608. As part of the resume section 608, the user's industries or opportunities of interest 610 may highlight the user's occupational interests, including the O*NET codes that go along with the occupations so that potential employers or recruiters can see what the user is interested in. At times there may be a career planner/matrix for the user that is presented using the social icons if a user selects to do so.

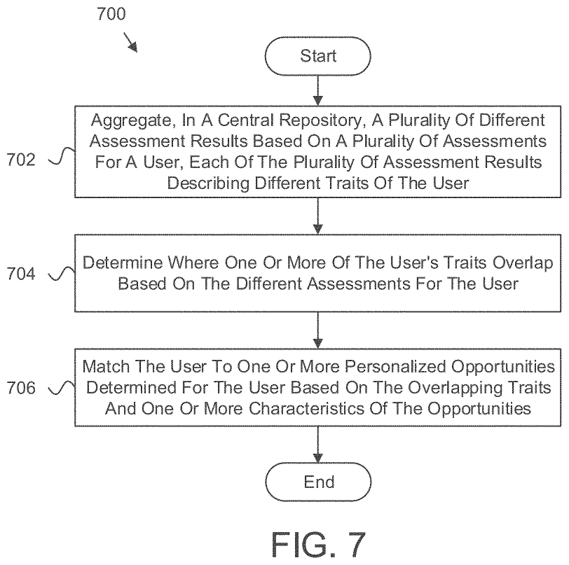

FIG. 7 depicts one embodiment of a schematic flow chart diagram of a method 700 for assessment-based talent matching. In one embodiment, the method 700 begins and the assessment results module 202 aggregates 702, in a central repository, a plurality of different assessment results based on a plurality of assessments for a user. Each of the plurality of assessment results may describe different traits of the user.

In further embodiments, the traits module 204 determines 704 where one or more of the user's traits overlap based on the different assessments for the user. In various embodiments, the opportunities module 206 matches 706 the user to one or more personalized opportunities determined for the user based on the overlapping traits and one or more characteristics of the opportunities, and the method 700 ends.

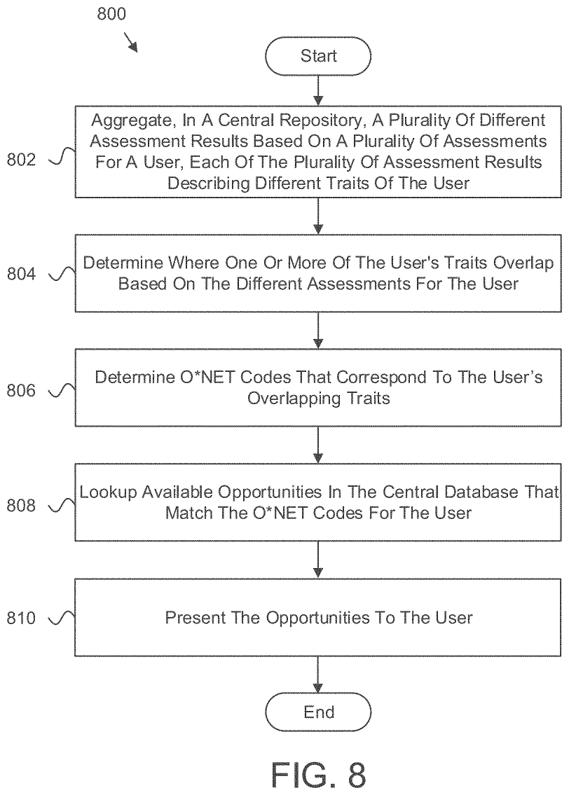

FIG. 8 depicts one embodiment of a schematic flow chart diagram of a method 800 for assessment-based talent matching. In one embodiment, the method 800 begins and the assessment results module 202 aggregates 802, in a central repository, a plurality of different assessment results based on a plurality of assessments for a user. Each of the plurality of assessment results may describe different traits of the user.

In further embodiments, the traits module 204 determines 804 where one or more of the user's traits overlap based on the different assessments for the user. The opportunities module 206 may determine 806 O*NET codes that correspond to the user's overlapping traits and may lookup 808 the available opportunities in the central database that match the user's O*NET codes. The opportunities module 206 may present 810 the available opportunities to the user, including contact and/or trait information for each opportunity provider, and the method 800 ends.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
a processor;
a memory that stores code executable by the processor to:
aggregate, in a central repository, a plurality of different assessment results based on a plurality of assessments for a user, each of the plurality of assessment results describing different traits of the user;
determine where one or more of the user's traits overlap based on the different assessments for the user; and
match the user to one or more personalized opportunities determined for the user based on the overlapping traits and one or more characteristics of the opportunities.

2. The apparatus of claim 1, wherein the one or more personalized opportunities are determined according to O*NET codes that correspond to the user's overlapping traits.

3. The apparatus of claim 1, wherein the code is executable by the processor to:
match the user to a professional associated with an organization offering the one or more personalized opportunities based on the user's traits being similar to the professional's traits; and
send a message from the user to the professional indicating the user's interest in the one or more personalized opportunities.

4. The apparatus of claim 1, wherein the code is executable by the processor to:
aggregate opportunities offered by one or more organizations in the central repository; and
organize the opportunities in the central repository by one or more O*NET codes for each of the opportunities.

5. The apparatus of claim 1, wherein the code is executable by the processor to:
receive a message intended for the user from an organization offering at least one of the personalized opportunities, the message comprising information about the personalized opportunity; and
deliver the message to the user at a graphical dashboard for the user.

6. The apparatus of claim 1, wherein the code is executable by the processor to receive a query from an organization for searching the central repository for one or more candidates who match one or more opportunities provided by the organization, the query comprising an O*NET code associated with the one or more opportunities.

7. The apparatus of claim 1, wherein the code is executable by the processor to track the user's location based on location data received from one or more location sensors for the user, the one or more personalized opportunities selected for the user based at least in part on the user's location.

8. The apparatus of claim 1, wherein the code is executable by the processor to:
determine staffing agencies that are used by organizations offering the one or more personalized opportunities; and
promote the user to the staffing agencies using the user's traits as determined from the one or more assessments.

9. The apparatus of claim 1, wherein the code is executable by the processor to:
include the user in one or more groups with other users; and
determine one or more traits of the one or more groups based on the individual traits of each user in the one or more groups according to the assessment results for each user.

10. The apparatus of claim 1, wherein the code is executable by the processor to:
identify one or more other users who have traits that are similar to the user's traits; and
present to the user at least a subset of the one or more other users that are located within a predetermined proximity of the user.

11. The apparatus of claim 1, wherein the code is executable by the processor to generate an electronic press kit for the user that describes the user's traits as determined based on the assessment results, the electronic press kit publicly accessible over a data network.

12. The apparatus of claim 11, wherein the electronic press kit comprises a digital portfolio for showcasing items related to the user's traits as determined by the user's assessment results.

13. The apparatus of claim 1, wherein the code is executable by the processor to export the user's data in the central repository to one or more organizations in response to the user providing consent to export their user data such that changes made to the data in the central repository are pushed to one or more organizations that have opted-in to receive data updates.

14. The apparatus of claim 13, wherein the code is executable by the processor to integrate with enterprise resource planning and business intelligence systems for the one or more organizations to present users who match with internal opportunities at the one or more organizations based on the assessment results for the users.

15. The apparatus of claim 1, the one or more personalized opportunities include a job, an internship, a service project, an internal promotion, an informational interview, a job shadow program, a mentorship program, an education program, an apprenticeship, and a scholarship.

16. The apparatus of claim 1, wherein the plurality of assessments is selected from the group consisting of a DISC assessment, a StrengthsFinder assessment, and a Self-Directed Search assessment.

17. A method, comprising:
aggregating, in a central repository, a plurality of different assessment results based on a plurality of assessments for a user, each of the plurality of assessment results describing different traits of the user;
determining where one or more of the user's traits overlap based on the different assessments for the user; and
matching the user to one or more personalized opportunities determined for the user based on the overlapping traits and one or more characteristics of the opportunities

18. The method of claim 17, wherein the one or more personalized opportunities are determined according to O*NET codes that correspond to the user's overlapping traits.

19. The method of claim 17, further comprising:
matching the user to a professional associated with an organization offering the one or more personalized opportunities based on the user's traits being similar to the professional's traits; and
sending a message from the user to the professional indicating the user's interest in the one or more personalized opportunities.

20. A computer program product comprising a computer readable storage medium that stores code executable by a processor, the executable code comprising code to:
aggregate, in a central repository, a plurality of different assessment results based on a plurality of assessments for a user, each of the plurality of assessment results describing different traits of the user;
determine where one or more of the user's traits overlap based on the different assessments for the user; and
match the user to one or more personalized opportunities determined for the user based on the overlapping traits and one or more characteristics of the opportunities.
